(19) United States
(12) Patent Application Publication
(10) Pub. No.: US 2026/0197778 A1
(43) Pub. Date: Jul. 9, 2026

(54) WIRELESS COMMUNICATION MODULE AND RELATED CONTROL METHOD WITH ADAPTIVE TIMING SYNCHRONIZATION CAPABILITY

(71) Applicant: Realtek Semiconductor Corp., HsinChu (TW)

(72) Inventors: Wen-Jen Hsieh, HsinChu (TW); Hsin-Wei Yu, HsinChu (TW)

(73) Assignee: Realtek Semiconductor Corp., HsinChu (TW)

(21) Appl. No.: 19/415,729

(22) Filed: Dec. 10, 2025

Related U.S. Application Data
(60) Provisional application No. 63/742,432, filed on Jan. 7, 2025.

(30) Foreign Application Priority Data
Nov. 25, 2025 (TW) 114146002

(51) Int. Cl. H04W 56/00; H04W 92/18

(52) U.S. Cl. CPC H04W 56/001; H04W 92/18

(57) ABSTRACT

A method for controlling a wireless communication module includes: causing the wireless communication module to establish a first connection and a second connection with a plurality of specific wireless communication modules, respectively; respectively maintaining a first timer for a first connection port corresponding to the first connection and a second timer for a second connection port corresponding to the second connection; selecting a target port from the first connection port and the second connection port according to a request from an application program interface corresponding to the wireless communication module; and in response to the request from the application program interface, returning a time value provided by the timer corresponding to the target port.

### CROSS REFERENCE TO RELATED APPLICATIONS

This application claims the benefit of U.S. Provisional Application No. 63/742,432, filed on January 7th, 2025. The content of the application is incorporated herein by reference.

### BACKGROUND OF THE INVENTION

### FIELD OF THE INVENTION

The present invention relates to wireless communications, and more particularly, to a wireless communication module with adaptive timing synchronization capability and a method for controlling the wireless communication module.

### DESCRIPTION OF THE PRIOR ART

In a conventional wireless network environment, devices typically rely on their respective system times to obtain time information. However, due to differences in system time calculation mechanisms and accumulation of hardware clock errors, time bases between different devices are often inconsistent, thereby limiting synchronization accuracy between devices. This negatively impacts certain application scenarios, especially those requiring high-precision synchronization, such as real-time interactive applications. Therefore, there is a need in the art for an innovative synchronization control mechanism to solve this problem.

### SUMMARY OF THE INVENTION

It is one object of the present invention to achieve adaptive timing synchronization on a wireless communication module. Specifically, the wireless communication module provided by the present invention can simultaneously establish and maintain multiple types of wireless network connections, including wireless network connections in basic service set (BSS) mode and peer-to-peer (P2P) mode, and maintain independent timing synchronization function (TSF) timers for each connection port respectively. The wireless communication module periodically updates timer corresponding to each connection port based on beacon frames or probe response frames received from different connection ports, ensuring that the time base remains consistent with other devices in the network it is in.

Furthermore, the wireless communication module of the present invention also supports an application program interface (API), allowing application layer programs to directly call the timer information maintained by the wireless network communication module. This enables applications to use more accurate time to coordinate cross-device operations. Compared to conventional methods that rely solely on independently running system times which are prone to deviation, the present invention effectively improves the timing accuracy of cross-device applications, and is particularly suitable for time-sensitive real-time interactive application scenarios.

According to one embodiment, a method for controlling a wireless communication module is provided. The method comprises: causing the wireless communication module to establish a first connection and a second connection with a plurality of specific wireless communication modules, respectively; respectively maintaining a first timer for a first connection port corresponding to the first connection and a second timer for a second connection port corresponding to the second connection; selecting a target port from the first connection port and the second connection port according to a request from an application program interface corresponding to the wireless communication module; and in response to the request from the application program interface, returning a time value provided by the timer corresponding to the target port.

According to one embodiment, a wireless communication module is provided. The wireless communication module comprises a wireless communication controller controlled by a driver. The wireless communication controller is configured to control the wireless communication controller to perform the following operations: cause the wireless communication module to establish a first connection and a second connection with a plurality of specific wireless communication modules, respectively; respectively maintain a first timer for a first connection port corresponding to the first connection and a second timer for a second connection port corresponding to the second connection; select a target port from the first connection port and the second connection port according to a request from an application program interface corresponding to the wireless communication module; and in response to the request from the application program interface, return a time value provided by the timer corresponding to the target port.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and FIG. 1B illustrate timing alignment under BSS mode

FIG. 2A and FIG. 2B illustrate timing alignment under P2P mode.

FIG. 3 illustrates timing alignment when both BSS and P2P modes coexist.

FIG. 4 illustrates a schematic diagram of a wireless communication module and related wireless communication device according to one embodiment of the present invention.

FIG. 5 illustrates a flow chart of a method for controlling a wireless communication module according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment”, “an embodiment” or “some embodiments” means that a particular feature, structure or characteristic described in connection with the embodiment or example is included in at least one embodiment of the present embodiments. Thus, appearances of the phrases “in one embodiment”, “in an embodiment” or “in some embodiments” in various places throughout this specification are not necessarily all referring to the same embodiment(s). Furthermore, the particular features, structures or characteristics may be combined in any suitable combinations and/or sub-combinations in one or more embodiments.

In the following description, the concepts of the present invention will be explained in conjunction with an access point (AP) 10 and wireless communication devices 20-40. However, it is worth noting that the number of these devices is not a limitation of the present invention. Furthermore, each of the wireless communication devices 20-40 includes a wireless communication module 50 of the present invention. In some embodiments, each of the wireless communication devices 20-40 may be a notebook computer, a desktop computer, a smartphone, a tablet computer, a game console, a VoIP phone, or any terminal device with wireless communication capabilities. In some embodiments, the wireless communication module 50 may be a Wi-Fi network interface card (NIC), such as a network interface device with 802.11 wireless communication capabilities, including embedded Wi-Fi network cards, external Wi-Fi network cards, and so on.

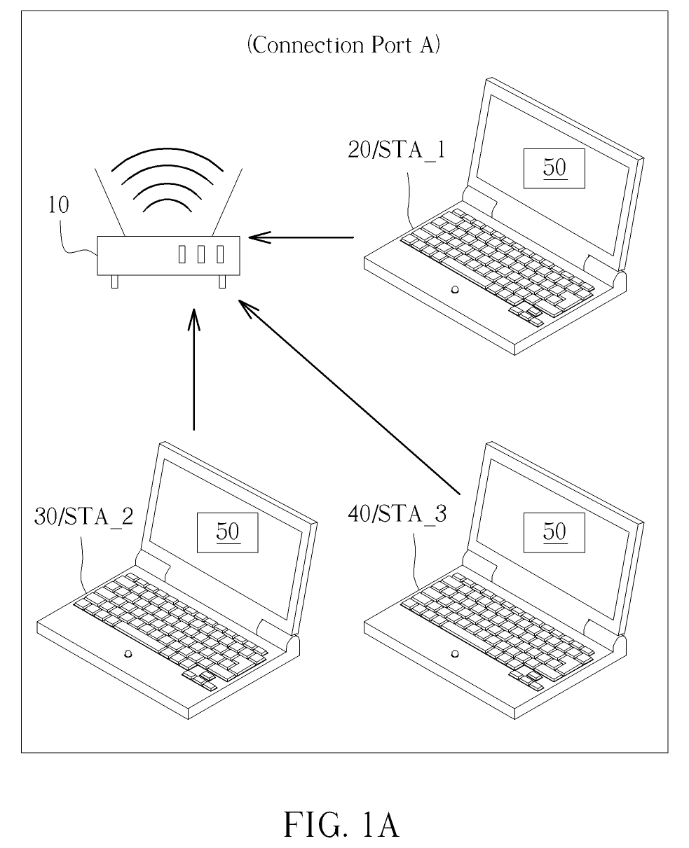

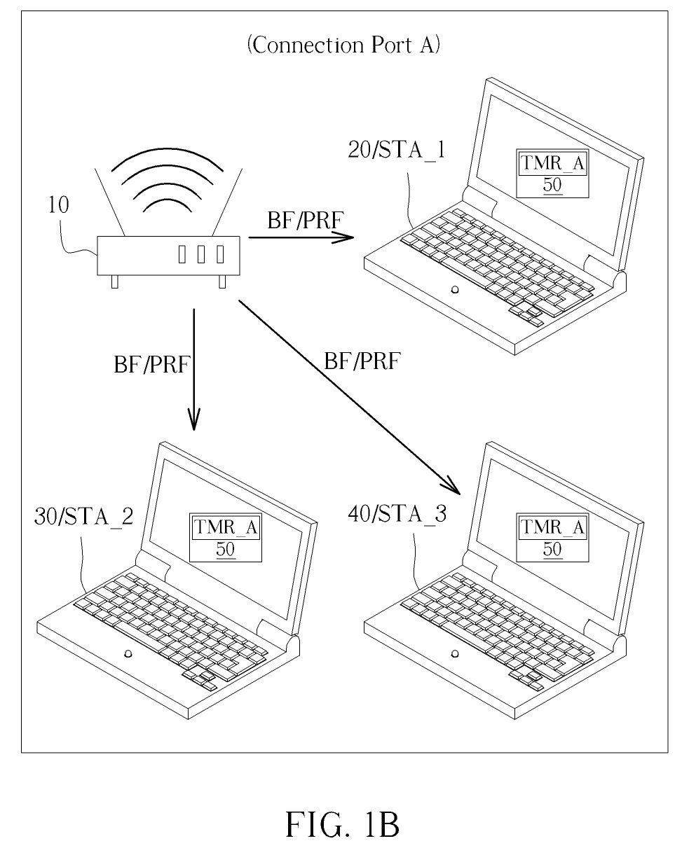

FIG. 1A and 1B illustrate how a wireless local area network including the AP 10 and wireless communication devices 20-40 under basic service set (BSS) mode, performs inter-device timing synchronization. As shown in FIG. 1A, under BBS mode, the wireless communication devices 20-40 act as stations STA_1-STA_3, respectively. The wireless communication module 50 in each of the wireless communication devices 20-40 connects to the AP 10 through a first connection port (e.g., Port A) and uses the first connection provided by the AP 10 to exchange information between devices. As shown in FIG. 1B, under BSS mode, the AP 10 periodically sends a beacon frame (“BF” in the figure) or a probe response frame (“PRF” in the figure) containing timing synchronization function (TSF) information to the wireless communication module 50 of each of the stations STA_1-STA_3 (i.e., wireless communication devices 20-40) via the first connection. In one embodiment, the TSF information may be a time value of a TSF Timer maintained by the AP 10. Furthermore, the wireless communication module 50 of each of the stations STA_1-STA_3 can extract the TSF information from the beacon frame or the probe response frame received from the first connection port to respectively maintain their own first timers TMR_A (i.e., TSF timers), thereby precisely aligning the timing of stations STA_1-STA_3 with the timing of AP 10.

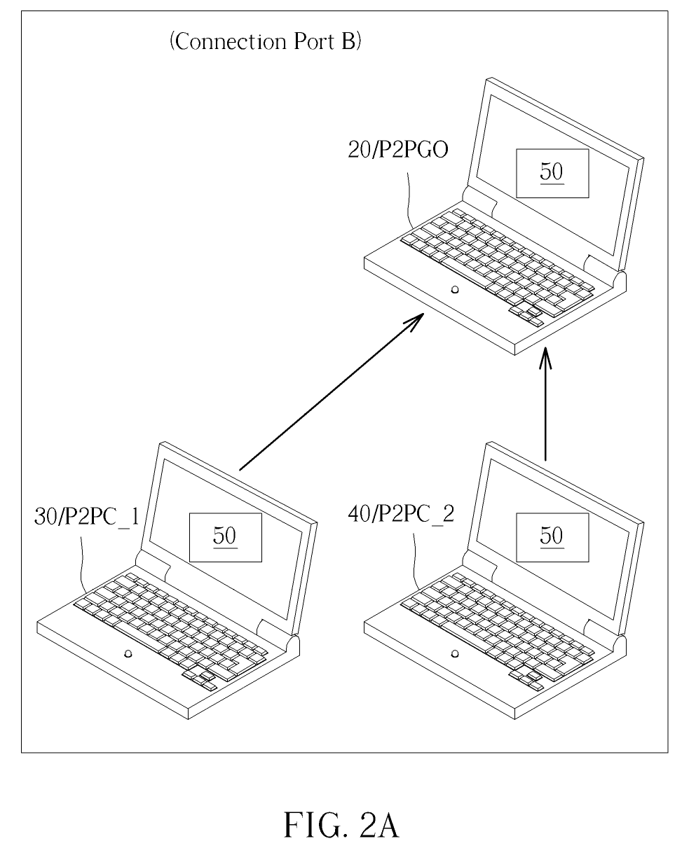

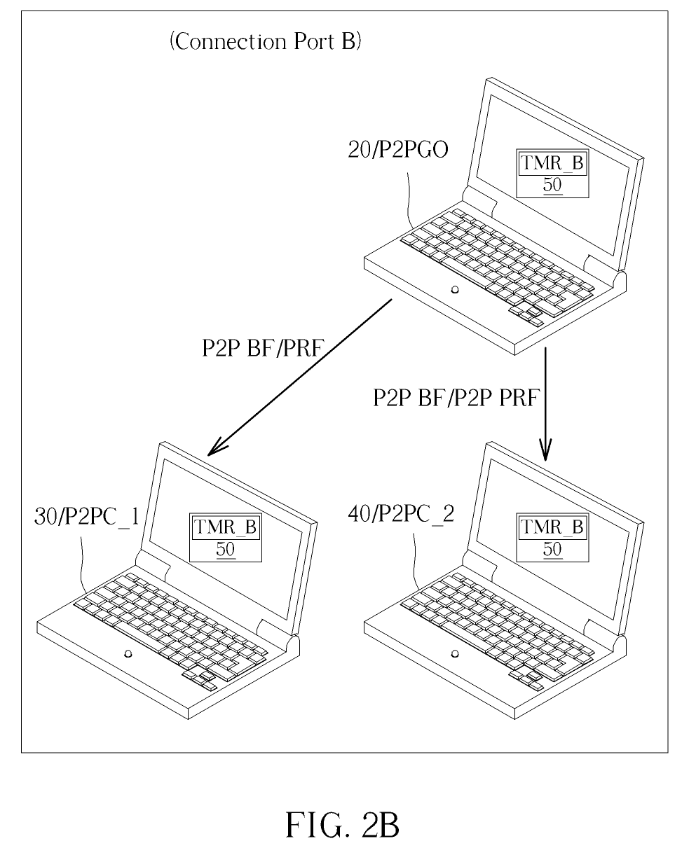

In addition to forming a wireless local area network with AP 10 based on the BSS mode, the wireless communication devices 20-40 can also form another wireless local area network under peer-to-peer (P2P) mode. Please refer to FIG. 2A and 2B. As shown in FIG. 2A, under P2P mode, the wireless communication device 20 can act as a P2P group owner (i.e., P2PGO), while the wireless communication devices 30-40 can act as P2P clients (i.e., P2PC_1 and P2PC_2). The wireless communication module 50 in each of the wireless communication devices 20-40 establishes a second connection through a second connection port (e.g., Port B), which is different from the first connection port, to perform P2P information exchange between devices. Furthermore, as shown in FIG. 2B, under P2P mode, the P2P group owner P2PGO (i.e., wireless communication device 20) will periodically send a P2P beacon frame (i.e., “P2P BF” in the figure) or a P2P probe response frame (“P2P PRF” in the figure) containing TSF information to the wireless communication module 50 of each of the P2P clients P2PC_1 and P2PC_2 (i.e., wireless communication devices 30-40) via the second connection. In one embodiment, the TSF information may be the time value of a TSF timer maintained by the wireless communication module 50 of the P2P group owner P2PGO. Furthermore, the wireless communication module 50 of each of the P2P clients P2PC_1 and P2PC_2 can extract the TSF information from the P2P beacon frame or P2P probe response frame received from the second connection port to respectively maintain their own second timers TMR_B, thereby precisely aligning the timing of the P2P clients P2PC_1 and P2PC_2 with the timing of the P2P group owner P2PGO.

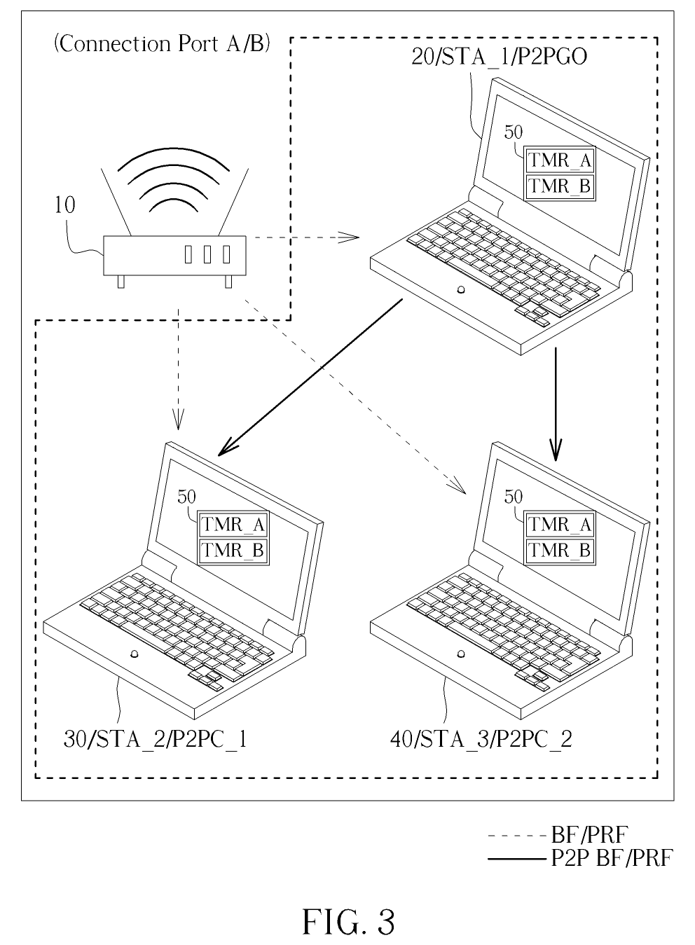

FIG. 3 illustrates timing synchronization when both the BSS mode and the P2P mode coexist. In such a scenario, while the wireless communication devices 20-40 form a wireless local area network with AP 10 under the BSS mode, the wireless communication devices 20-40 also form another wireless local area network among themselves under P2P mode. At this time, the wireless communication module 50 in each of the wireless communication devices 20-40 maintains the first timer TMR_A based on the TSF information contained in the beacon frame or the probe response frame received from the first connection port, and simultaneously maintains the second timer TMR_B based on the TSF information contained in the P2P beacon frame or the P2P probe response frame received from the second connection port.

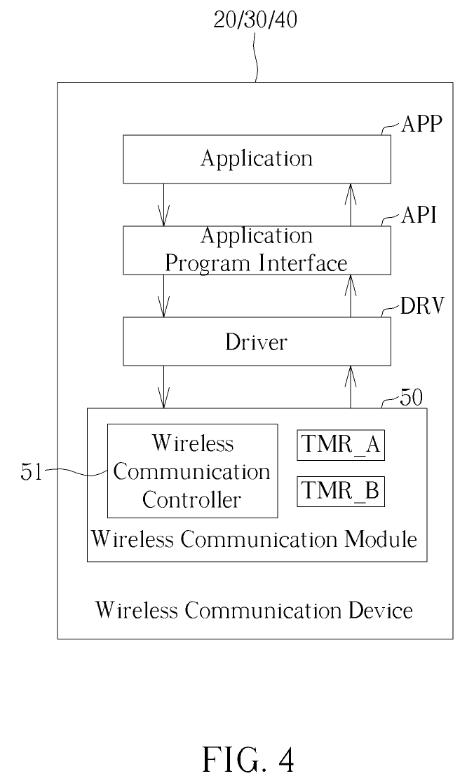

FIG. 4 illustrates a schematic diagram of a wireless communication module and a related wireless communication device according to one embodiment of the present invention. As shown in the figure, the wireless communication module 50, located in the wireless communication device 20/30/40, includes a wireless communication controller 51. The wireless communication device 20/30/40 can control operations of the wireless communication controller 51 through a driver DRV, thus enabling the wireless communication device 20/30/40, to which the wireless communication module 50 belongs, to communicate wirelessly with other devices. Furthermore, the wireless communication module 50 also supports information calls via an application program interface (API). An application APP running on the wireless communication device 20/30/40 can request and obtain a time value of a timer corresponding to a specific connection port from the wireless communication module 50 by calling the API. In response to the request from the API, the wireless communication module 50 can select a target port from among the connection ports used by all established wireless network connections and return the timer time value corresponding to the target port to the application APP through the driver DRV and the API.

For example, when the application APP is an application highly sensitive to timing alignment, such as a real-time voice call application, and exchanges information through the aforementioned P2P mode wireless network connection, the application APP can send a request to the API. Upon receiving the request, the wireless communication module 50 will select the corresponding target port and return the time value of the corresponding timer. In this way, the application APP can obtain a reference time value for the P2P connection, allowing the timing for the application APP to process voice packets to be more precise.

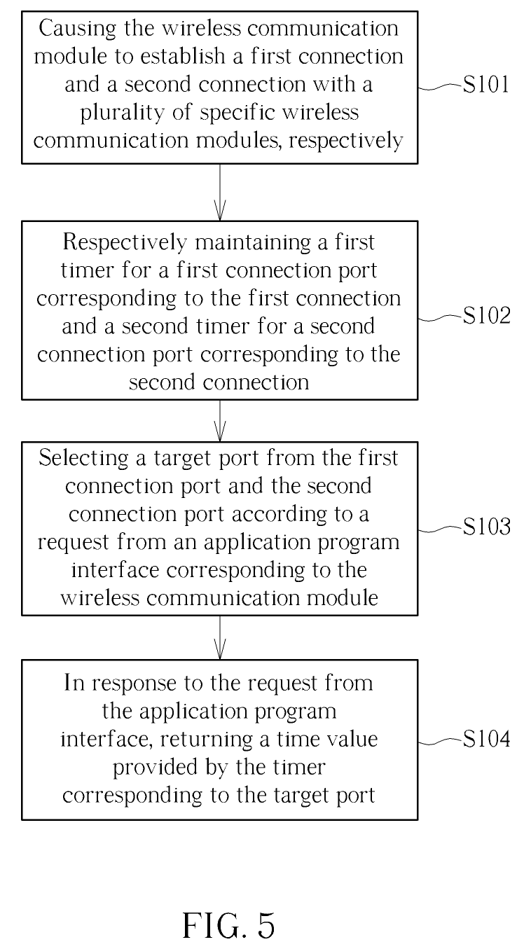

FIG. 5 illustrates a flow chart of a method for controlling a wireless communication module according to one embodiment of the present invention, which includes steps of:

S101: causing the wireless communication module to establish a first connection and a second connection with a plurality of specific wireless communication modules, respectively;

S102: respectively maintaining a first timer for a first connection port corresponding to the first connection and a second timer for a second connection port corresponding to the second connection;

S103: selecting a target port from the first connection port and the second connection port according to a request from an application program interface corresponding to the wireless communication module; and

S104: in response to the request from the application program interface, returning a time value provided by the timer corresponding to the target port.

Since the principles and details of the above steps have been explained in detail in the above embodiments, they will not be repeated here. It is worth noting that the above process can be further improved in terms of accuracy and efficiency of timing synchronization by adding additional steps or making appropriate modifications and adjustments.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a wireless communication module, comprising:
causing the wireless communication module to establish a first connection and a second connection with a plurality of specific wireless communication modules, respectively;
respectively maintaining a first timer for a first connection port corresponding to the first connection and a second timer for a second connection port corresponding to the second connection;
selecting a target port from the first connection port and the second connection port according to a request from an application program interface corresponding to the wireless communication module; and
in response to the request from the application program interface, returning a time value provided by the timer corresponding to the target port.

2. The method of claim 1, wherein the first timer and the second timer are timing synchronization function (TSF) timers.

3. The method of claim 1, wherein the first connection is a wireless network connection between a basic service set (BSS) under a BSS mode, and the BSS includes an access point and a plurality of stations, wherein the wireless communication module and the plurality of specific wireless communication modules are respectively disposed in the plurality of stations.

4. The method of claim 1, wherein the second connection is a wireless network connection between a peer-to-peer (P2P) communication group under a P2P mode, and the P2P communication group includes a P2P group owner and a plurality of P2P clients, wherein the wireless communication module and the plurality of specific wireless communication modules are respectively disposed in the P2P group owner and the plurality of P2P clients.

5. The method of claim 1, wherein the step of respectively maintaining the first timer and the second timer comprises:
extracting first timing synchronization information from a beacon frame or a probe response frame received from the first connection port, and maintaining the first timer according to the first timing synchronization information; and
extracting second timing synchronization information from a beacon frame or a probe response frame received from the second connection port, and maintaining the second timer according to the second timing synchronization information.

6. A wireless communication module, comprising:
a wireless communication controller, controlled by a driver, wherein the driver is configured to control the wireless communication controller to perform the following operations:
cause the wireless communication module to establish a first connection and a second connection with a plurality of specific wireless communication modules, respectively;
respectively maintain a first timer for a first connection port corresponding to the first connection and a second timer for a second connection port corresponding to the second connection;
select a target port from the first connection port and the second connection port according to a request from an application program interface corresponding to the wireless communication module; and
in response to the request from the application program interface, return a time value provided by the timer corresponding to the target port.

7. The wireless communication module of claim 6, wherein the first timer and the second timer are timing synchronization function (TSF) timers.

8. The wireless communication module of claim 6, wherein the first connection is a wireless network connection between a basic service set (BSS) under a BSS mode, and the BSS includes an access point and a plurality of stations, wherein the wireless communication module and the plurality of specific wireless communication modules are respectively disposed in the plurality of stations.

9. The wireless communication module of claim 6, wherein the second connection is a wireless network connection between a peer-to-peer (P2P) communication group under a P2P mode, and the P2P communication group includes a P2P group owner and a plurality of P2P clients, wherein the wireless communication module and the plurality of specific wireless communication modules are respectively disposed in the P2P group owner and the plurality of P2P clients.

10. The wireless communication module of claim 6, wherein the driver is configured to control the wireless communication controller to perform the following operations:
extract first timing synchronization information from a beacon frame or a probe response frame received from the first connection port, and maintain the first timer according to the first timing synchronization information; and
extract second timing synchronization information from a beacon frame or a probe response frame received from the second connection port, and maintain the second timer according to the second timing synchronization information.
